(19) United States
(12) Patent Application Publication
(10) Pub. No.: US 2008/0150315 A1
(43) Pub. Date: Jun. 26, 2008

(54) Substance dynamic flow diverter for use with a vehicle to cause energy savings

(76) Inventor: Papineau Benoit, Jackson Heights, NY (US)

Correspondence Address: HUDAK, SHUNK & FARINE, CO., L.P.A., 2020 FRONT STREET, SUITE 307, CUYAHOGA FALLS, OH, 44221, US

(21) Appl. No.: 11/807,735

(22) Filed: May 30, 2007

Related U.S. Application Data
(60) Provisional application No. 60/809,381, filed on May 30, 2006.

(51) Int. Cl. B60J 1/20

(52) U.S. Cl. 296/91

(57) ABSTRACT

The invention is a dynamic flow diverter for a vehicle having a windshield. The flow diverter has a deflector which comprises a sphere or some portion of a sphere or a cone, such as about half of a sphere with a flat top that is substantially parallel to a planar top surface of a base. The base includes a bottom surface with an adhesive or a magnet that holds the diverter to the vehicle for the after market version. In OEM version, the diverter may permanently secured to the vehicle. In both cases, a link holds the deflector in a spaced relation to the vehicle at an optimal distance and location to deflect air away from the windshield so as to cause energy savings and to make the vehicle more responsive.

This Application is Based on U.S. Provisional Application Ser. No. 60/809,381, filed on May 30, 2006

### FIELD OF THE INVENTION

The invention relates to a substance dynamic flow diverter which is used on the front of a vehicle to divert wind flow about or above a vehicle wind shield which results in a low pressure in front of the vehicle and causes higher energy efficiencies. The invention further relates to a method of making a vehicle more energy efficient by placing a dynamic flow diverter in a spaced relation to a vehicle windshield so as to divert sir flow from the vehicle windshield during use.

### BACKGROUND OF THE INVENTION

The field of transportation for the past century has been dominated by the gasoline engine and for the past 50 years by the increasing realization of the dangers of dependence on oil as a diminishing resource. While alternative energy sources are being developed, they also suffer from efficiency issues which keep them from being totally acceptable substitutes. Consequently, advances which relate in greater energy efficiency are highly desirable and promote both the national economy and national security.

In the past, flow dynamics have been considered for improving energy efficiency of vehicles but designs that are dictated entirely by these considerations present problems with ergonometric and with aesthetic considerations. For example, given the amount of time that can be spent in a vehicle, it is desirable for the driver to be able to sit upright. Moreover, for safety reasons, the driver needs to have a relatively straight and open line of visibility. Consequently, windshields have been developed at angles which do not provide for the greatest flow efficiency. The present invention addresses this issue and provides substantial energy savings and potential time savings by diverting the wind before it gets to the windshield while avoiding the problem that the device itself increases the air resistance. The compact size of the present invention does not obstruct the vision of the driver or the passengers. The device can be incorporated in the construction of new cars, and alternatively can be added as an after market add-on to improve the mileage by up to 15 to 25% on average. The invention is useful for various modes of powering a vehicle, including the combustion engine powered by various fuels including gasoline, diesel fuel, and various other hydrocarbon fuels, and electric engines powered by batteries, and solar cells as well as by fuel cells. The energy savings resulting from the present invention depend on the size of the engine, and the angle of the windshield. The habits of the driver do not seem to affect the efficiency of the invention and the tests run with the invention suggest that the device causes the same rate of savings regardless of the rate of acceleration or deceleration.

### SUMMARY OF THE INVENTION

The invention comprises a substance flow diverter which includes a deflector having a curved bottom and preferably has a flat top surface, a base which has a means of attachment to the vehicle, and a shaft which holds the deflector at an optimal height for the windshield in question. The curved bottom of the deflector faces the vehicle and is preferably some portion of a sphere, and more preferably is at least a third of a sphere. In a further embodiment, the bottom is curved, but is a more complex curve, such as a portion of a cone, where the apex of the cone face the vehicle hood. In this embodiment, the cone preferably is bilaterally symmetrical relative to the median line of the vehicle, but may have a shape that is not symmetrical front to back. Thus, the front may have a rounded front surface and a more tapered rear surface, or alternatively, the deflector may approximate the shape of a cone having circular cross-sections of increasing diameter when taken from the bottom toward the top. This second embodiment is preferable for larger vehicles where the deflector may cause air to be taken in from the side of the vehicle.

The top of the deflector is flat and oriented substantially parallel to the base. The deflector is preferably relatively smooth, and can be made from appropriate durable materials, such as metal, ceramic, or plastic, with a relatively smooth finish, which can optimized for performance keeping aesthetic considerations in mind. For use in new vehicles, the base can be a simple as an attachment means, such as a screw attachment, or the base could telescope into the hood of the vehicle, for example for a new construction. In addition in these new car designs, the device could incorporate lights for viewing, and could even rotate in the direction that the vehicle is moving to act as headlights, or for enhancement of the vehicles appearance. For an after market device, the base could be a flat base of an appropriate shape, such as triangular, that provides a surface for a magnet or an adhesive which is strong enough to hold the deflector to the vehicle during use. The invention is attached to a vehicle hood in front of the windshield. The shaft is a rigid post, which can be a cylindrical rod, but is preferably a post having as flat a profile as possible with the front angle facing into the wind. The shaft is attached to the deflector along the longitudinal axis of the sphere.

### BRIEF DESCRIPTION OF THE DRAWINGS

FIG. 1 is a side view of a first embodiment of a flow diverter of the present invention;

FIG. 2 is a cross section of the flow diverter of FIG. 1 taken at line 2-2;

FIG. 3 is a top view of the flow diverter of the FIG. 1;

FIG. 4 is a side perspective view of the flow diverter of FIG. 1 in place on an automobile hood;

FIG. 5 is a front view of a second embodiment of the flow diverter of the present invention in position on an automobile hood; and

FIG. 6 is a front view of a third embodiment of the flow diverter of the present invention in place on an automobile; and

FIG. 7 is a side view of a second embodiment of the flow diverter of the present invention.

### DETAILED DESCRIPTION OF THE INVENTION

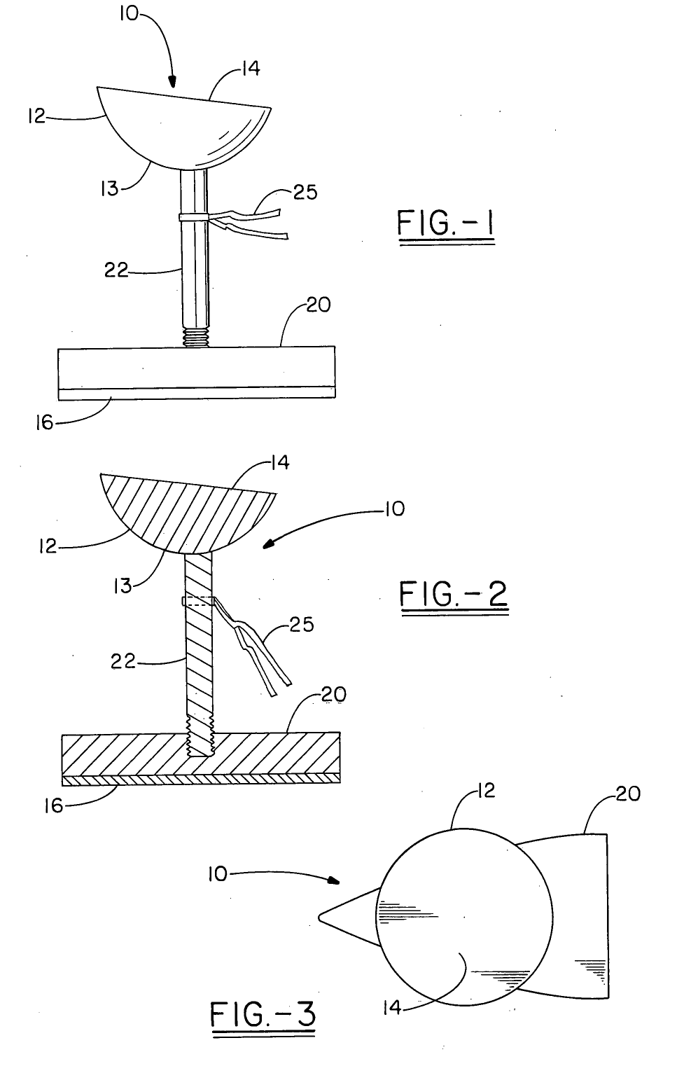

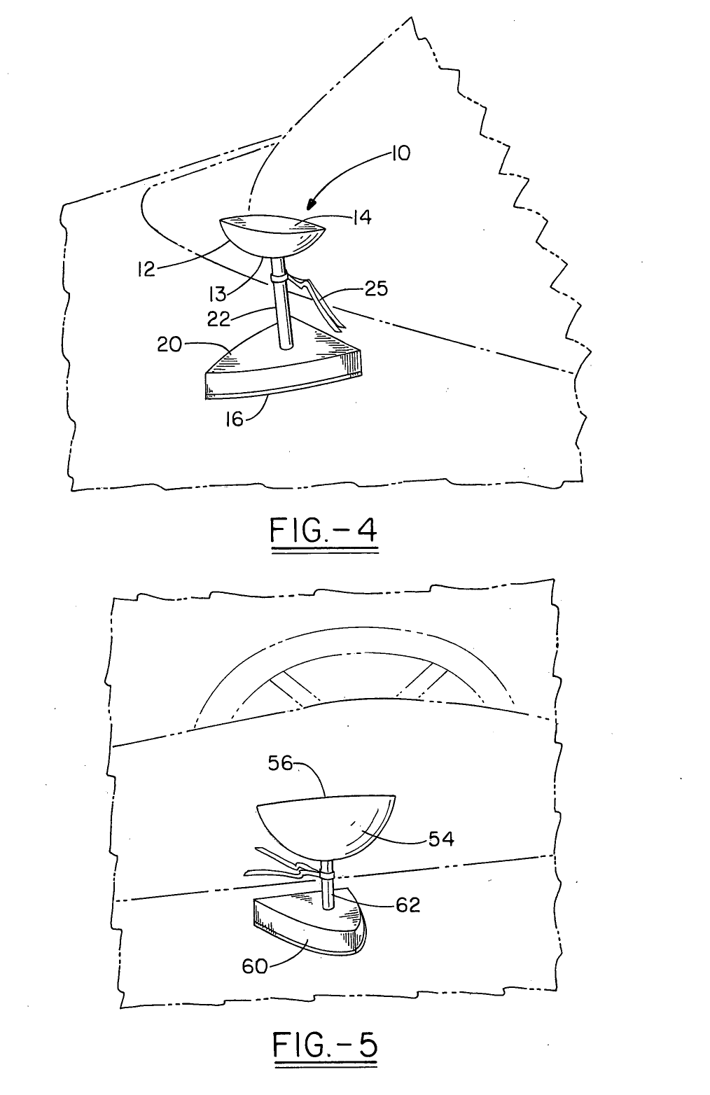

A first embodiment of the flow diverter of the present invention is shown in FIG. 1. The flow diverter shown generally at 10 includes a deflector 12 which has a rounded bottom portion 13 which faces the vehicle to which it is attached. In the first embodiment, the bottom is preferably spherical, and more preferably is a portion of a sphere of between about 25% and 50%, and most preferably about a third of a sphere. In a second embodiment, the bottom is not symmetrical in the vertical direction, and may be cone shaped, or may have a more complex smoothly curving configuration which is bilaterally symmetrical, but not necessarily round in cross-section, and may have a cross-section that mirrors the tear-drop shape of an airplane wing.

The top 14 of the deflector is preferably flat, and forms sharp angles with the bottom portion of the deflector 12. The top surface could form a right angle to the base or could angle up to about 25° from the right angle with the front of the deflector forming the sharper angle and the back of the deflector relative. The deflector 12 is held to a base 20 which forms the means of holding the flow diverter to the vehicle. In an embodiment which is intended for after market use, (i.e., in which the diverter is installed on an existing vehicle rather than one being constructed), the base provides a platform of sufficient surface area to allow the diverter to be held onto the vehicle and to resist the force of deflection by the flow which it encounters. The base also includes an attachment means, which could be a permanent fastener, or a detachable fastener. Examples of the detachable fasteners include magnets or adhesive. A construction which has been found to be acceptable is a base having a surface area of about 0.5 to about 15 inch², and having a magnetic strip attached adhered thereto which is sufficiently strong to hold the diverter to the vehicle during use. In a second embodiment in which the diverter is included in new automobiles, the base can consist more simply of an attachment means, such as a screw or a retractable link which can be extended into a working position or into a retracted position for storage or washing.

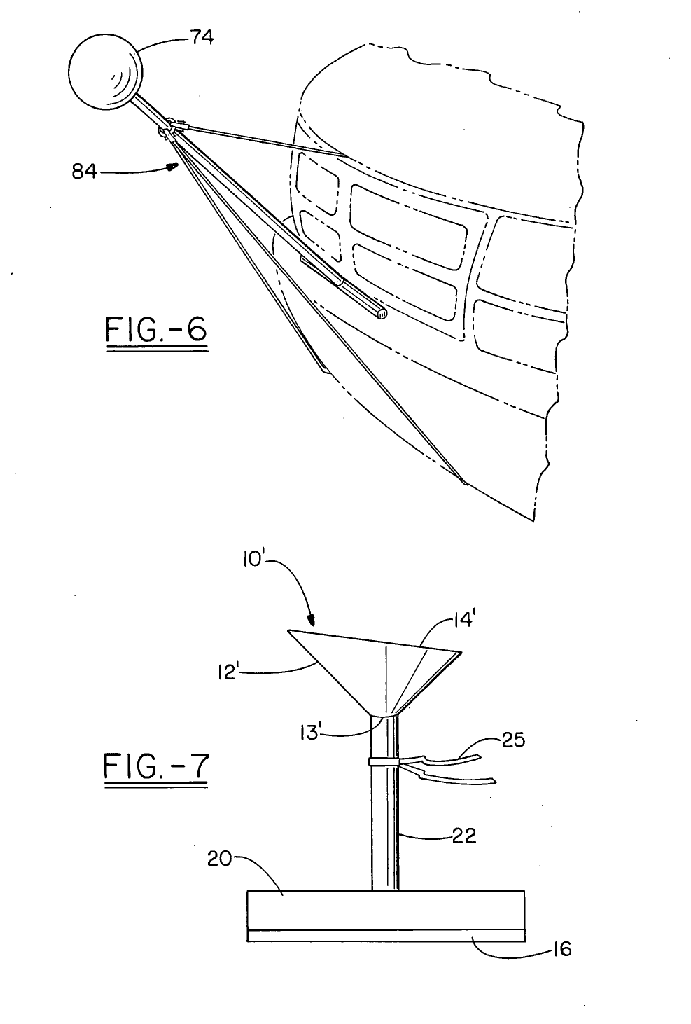

The diverter 10 further includes a link which holds the deflector rigidly at a given height above the base. The link could be a post or rod, or perhaps more preferably could be a flat, teardrop, or round link (in cross-section taken at a line normal to the long axis of the link) for which the sharp angle faces into the flow. The link can be held in the base and the deflector can be held on the link by various means, including the illustrated mechanical screw means, but it can also be welded or otherwise made as a unitary piece. The link 22 needs to have sufficient strength and rigidity to hold the deflector in the desired position to divert the air flow above and about the windshield. The diverter further includes one or more streamers 25 which can be used to help determine the optimal position for the diverter on a vehicle given the air flow conditions. For example, in a cross wind, the diverter might be positioned at a slightly different position or angle so that the streamer flags straight behind the deflector. The deflector preferably has a radius of from about 0.5 inch to about 3.0 inches, and more preferably from about 1.0 to about 2.0. The optimal size will depend on the average speed that the driver drives. The top of the deflector has a surface area of about 0.5 to about 30 inch² which is at about 80 to 100°, and preferably about 85 to about 95°, i.e. about 90°, to the top surface of the base. The deflector is optimally located in the center of the hood and from about 0 to about 3 inches in back of the windshield. In the embodiment shown in FIG. 5, the deflector has a rounded bottom portion 54 which forms approximately half of a sphere. The deflector further includes a link 62 which holds the bottom to the base 60. In this embodiment, the flat top of the bottom portion 56 is not parallel to the top surface of the base member, but rather forms an angle sloping backwards towards the windshield in use. The top 56 forms an angle of from about 0° to about 20° to a plane parallel with the top surface of the base. In the embodiment shown in FIG. 6, the deflector comprises a full sphere 74 which is larger than that shown in the other embodiments, and specifically is from about 3 to about 10 inches in diameter. The deflector is held to a base 82 which secures the deflector to the front of the automobile, for example, at the grill. A link 84 holds the deflector in front of and slightly above the front hood of the automobile so as to cause a diversion of air from the front windshield of the automobile. The length of the link will depend on the point of attachment of the base, but may vary between about 3 and about 20 inches. The deflector is further secured, for example, by cables which from a triangular support.

The invention is generally placed on the vehicle hood about an inch from the end of the end of the hood in front of the wipers, and centered between the two sides of the car. For more optimal positioning to maximize the energy efficiency, the diverter should be placed so that the flow is directed directly behind the deflector. For example, in a high cross wind, the deflector may be rotated into the air flow. However, the diverter has proved to improve the fuel efficiency and to provide for other advantages without very close attention to the exact placement of the device. For city driving the invention can be placed slightly closer to the windshield, and for highway driving somewhat father back from the windshield. This difference may be only about ½ inch. The location may also depend on the shape of the windshield. The sound of the wind can be used as an indication of where the effects of the deflector come from, for example, wind which enters the windshield from the sides.

The invention can be better understood with reference to the following examples which illustrate its use and advantages.

### EXAMPLE 1

As a test of the efficiency of the present invention, six different types of vehicles were used in a test in which the invention was used and was compared to the EPA ratings as a control. The vehicles were rented and driven by the inventor. The driver was randomly assigned one of the five cars in the compact to mid-size category. The cars were the Chevy Aveo, the Dodge Stratus, the Hyundai Elantra, the Hyundai Accent, the Pontiac Sunfire, and the Chevy Cobalt. For at least three of the cars, multiple cars were rented and tested. All testing was done on low mileage used 2005 models and in sub-freezing temperatures. The cars were driven at least 200 miles per test period, with substantially all driving on highway and on cruise control to assure as uniform as possible speeds of 70 mph. The gasoline was always regular, although the brand was not always the same. When multiple cars of the same type were used, the results were averaged to provide the information set forth in Table 1.

In Table 1, the first column is the EPA rating at 48 mph, the second column is the EPA minus 15% to account for the reduction for a higher rate of speed (70 miles per hour “mph”). The EPA mileage was used as a control rather than the actual mileage without the invention in order to allow the test data with the invention to be maximized. The third column represents the actual mpg recorded for the vehicle driven with the present invention in place. The fourth column represents the time savings for travel at 70 mph instead of 48 mph. The last column represents the percentage increase in the miles per gallon, “mpg”.

As a test of the test procedure and the use of the EPA rating, an actual comparison of the mileage with and without the invention for the 2005 Pontiac Sunfire was performed and this test verified the test assumption that the EPA rating could be used discounted for the higher rate of speed without compromising the results of the use of the invention. The discounted estimated mileage using the method of the present example was 28 mpg, and actual mileage without using the present invention was 27.75 mpg, tested over 200 miles half with a head wind, and half without, traveling in one direction and back in the opposite direction over the same road. This example illustrates that the discounted EPA mileage does not substantially understate the mileage of the test vehicles (and in fact, may overstate the mileage) without use of the present invention, so as to overestimate the advantage presented by the invention.

TABLE 1

| Car | | Est | Test | | % |
|---|---|---|---|---|---|
| type | EPA | MPG | MPG | time | improve |
| Aveo | 35 | 30.43 | 34.6 | 40% | 17.7 |
| Stratus | 29 | 25.22 | 29.2 | 40% | 15.78 |
| Elantra | 33 | 28.7 | 36 | 40% | 24.1 |
| Accent | 35 | 30.43 | 37.5 | 40% | 23.2 |
| Sunfire | 34 | 29.6 | 32.5 | 40% | 9.8 |
| Cobalt | 32 | 28 | 36.5 | 40% | 30.3 |
| | | | | | ave/20.26 |

### EXAMPLE 2

In this test, privately owned used cars (both newer and older models) were tested for actual mileage compared with and without the present invention. The results of the tests are shown in Table 2. The cars were not driven by the first driver, the inventor, but instead by the owners of the cars without any change of their customary driving habits. The first car was a 1994 Jeep Cherokee loaded with an approximately 450 pounds load (which included three passengers and their luggage). It was driven along Interstate 87 from Montreal to New York City. The first column is the EPA rating at 48 mph. The second column is the actual mpg without the invention, and the third column is the actual mpg with the invention. The fourth column is the actual computed gasoline efficiency. In addition to the noted fuel savings, it is noted that for mountainous driving in the Adirondacks, the car with the cruise control on decelerated more without the invention than with the invention. For example, without the invention, the car would decelerate down to 65 mph or lower without the invention, but would hold a constant speed using the invention. The second car is a 2003 Lexus RX 300 SUV. The car was driven about town and on highway. All of the data was generated by the computer in the car. The results are also shown in Table 2 along with the results from the first car. A third car was tested using these conditions, and is a 92 Buick Regal. This car was tested against the EPA ratings as the driver of that car does not want to relinquish the use of the invention to provide for an actual control.

TABLE 2

| car | EPA | control | | % |
|---|---|---|---|---|
| type | est | mpg | mpg test | improve |
| 94 Jeep | 21 | 17.2 | 21.5 | 25 |
| 03 | 20 | 19.8 | 22.8 | 15.1 |
| Lexus | | | | |
| 92 | 28 | 24.34 | 33.7 | 38.4 |
| Regal | | | | |

The foregoing results demonstrate the efficiency of the present invention in improving the energy efficiency and providing other advantages by providing for improved substance flow dynamics.

While in accordance with the patent statutes the best mode and preferred embodiment have been set forth, the scope of the invention is not limited thereto, but rather by the scope of the attached claims.

What is claimed is:

1. A flow diverter for a vehicle having a windshield comprising a deflector which has a convexly rounded bottom portion for facing the hood of the vehicle in front of the windshield and which has substantially flat top surface and a link which holds the deflector in position spaced from the windshield during use of the vehicle.

2. A flow diverter as set forth in claim 1 wherein the deflector forms a portion of a sphere or a cone.

3. A flow diverter as set forth in claim 2 wherein the deflector forms from about ⅓ to about ¾.

4. A flow diverter as set forth in claim 3 wherein the deflector forms from about 45% to about 55% of a sphere.

5. A flow diverter as set forth in claim 4 wherein the deflector further includes a base which is capable of being removably connected to the vehicle.

6. A flow diverter as set forth in claim 5 wherein the base includes a lower surface which includes one or more of an adhesive and a magnet.

7. A flow diverter as set forth in claim 6 wherein the link extends between the base and the deflector and is from about 0.5 to about 20 inches in length.

8. A flow diverter as set forth in claim 6 wherein the deflector has a diameter which is from about 1.5 to about 10 inches.

9. A flow diverter as set forth in claim 1 wherein the deflector has a substantially smooth surface.

10. A flow diverter as set forth in claim 7 wherein the link has a cross section which is circular, oval, elliptical or oblate.

11. A vehicle comprising an upright windshield and a surface in front of the windshield which includes a flow diverter comprising a deflector which is held in a spaced relation to the surface and to the windshield by a link, the deflector forming at least a portion of a sphere or a cone which has a diameter of from about 1.0 to about 20 inches and the link having a length of from about 1.0 to about 20 inches.

12. A vehicle as set forth in claim 11 wherein the deflector comprises a portion of a sphere or a cone and further has a substantially flat top surface.

13. A vehicle as set forth in claim 12 wherein the flow diverter has a substantially smooth surface.

14. A vehicle as set forth in claim 13 wherein the link has a cross section which is circular, oval, elliptical or oblate.

15. A vehicle as set forth in claim 14 wherein the flow diverter further includes a base which includes means to attach the flow diverter to the vehicle.

16. A vehicle as set forth in claim 15 wherein the base has a planar bottom surface and a planar top surface and the top surface of the deflector is substantially parallel to the top surface of the base.

17. A vehicle as set forth in claim 16 wherein the bottom surface of the base includes one or more of an adhesive or a magnet.

18. A method of improving the energy efficiency of a vehicle having a substantially upright windshield and a surface in front of the windshield comprising the step of
attaching a flow diverter to the surface in front of the windshield, the flow diverter comprising a deflector, a link and a base, the deflector forming from about 30 to about 75% of a sphere with a diameter of from about 1 to about 20 inches and having a top surface which is substantially flat, and the link holding the deflector in a spaced relation to the windshield and to the surface such that the deflector diverts the flow of air away from the windshield during movement of the vehicle.

19. A method as set forth in claim 18 wherein the flow diverter includes a magnetic base so that the flow diverter can be removably attached to the vehicle without damaging the surface.

20. A method as set forth in claim 19 wherein multiple flow diverters are attached to the vehicle.
